(19) United States
(12) Patent Application Publication
(10) Pub. No.: US 2013/0026029 A1
(43) Pub. Date: Jan. 31, 2013

(54) PHOTO-ELECTROCHEMICAL CELL

(71) Applicants: Sam Kayaert, Leuven (BE); Johan Martens, Huldenberg (BE); Kasper Masschaele, Korbeek-Dijle (BE)

(72) Inventors: Sam Kayaert, Leuven (BE); Johan Martens, Huldenberg (BE); Kasper Masschaele, Korbeek-Dijle (BE)

(21) Appl. No.: 13/639,811

(22) PCT Filed: Apr. 8, 2011
(86) PCT No.: PCT/BE11/00020

§ 371 Date: Oct. 5, 2012

Related U.S. Application Data
(60) Provisional application No. 61/459,616, filed on Dec. 15, 2010.

(30) Foreign Application Priority Data
Apr. 8, 2010 (GB) 1005862.6
Dec. 6, 2010 (GB) 1021309.8

(51) Int. Cl. C25B 9/18; C25B 15/02; B82Y 30/00

(52) U.S. Cl. 204/230.8; 204/248; 204/230.2; 977/734; 977/932; 977/742

(57) ABSTRACT

CO2 conversation into organic molecules is based on the photo-oxidation of water into oxygen gas O2, protons H+, and electrons. The conversion of CO2 occurs at the photo-cathode and involves the generated protons, electrons and the “fuel” CO2.

### BACKGROUND OF THE INVENTION

A. Field of the Invention

Present invention concerns a dual function photo-electrochemical cell for conversion of light and streams of moistened gas and carbon dioxide containing gas (e.g. air) into organic compounds such as useful alcohol or hydrocarbon chemicals or fuels. This dual function photo-electrochemical cell is characterized in that the cell comprises a multifunctional photocatalytic system with a first anode photocatalyst unit (6) to photo-oxidize water of the moistened gas into oxygen which first anode photocatalyst electrode (1) is by a charge transport means (3) to transport of the electrons and protons to the cathode in contact with or associated with a cathodic photocatalyst electrode (2) of a second photocatalytical unit (7) to reduce CO2 which cell is further characterized in that it comprises at least one radiation means (4)—for radiation of the photocatalyst (1) of the first unit (6) and at least one radiation means (5)—for radiation of the photocatalyst (2) of the second unit (7). The positive charge (protons H+) transport means (3) can be sandwiched or positioned between the two photocatalyst electrode of the different photocatalytic material or different character functionality so that these electrode can be optimally been radiated at their photocatalytic surface.

Several documents are cited throughout the text of this specification. Each of the documents herein (including any manufacturer's specifications, instructions etc.) is hereby incorporated by reference; however, there is no admission that any document cited is indeed prior part of the present invention.

B. Description of the Related Art

Technologies have been developed for removing carbon from the atmosphere and depositing it in CO2 reservoirs for instance underground storage. Moreover CO2 can be captured as a pure by-product in processes such as for instance the processes related to petroleum refining, from flue gases from power generation or of intensive animal farming practices. These several carbon capture and sequestration sites form create low cost and relative pure CO2 sources.

The conversion of CO2 into useful chemicals is a long-standing issue. The principle of concept of most of the proposed devices is based on the electrochemical reduction of CO2 by means of a wide variety of catalysts in combination with specifically chosen electrolytes. The reduction of CO2—without an applied high bias to overcome the over-potentials—requires sufficient electrons and protons and an appropriate catalyst system. Though many solutions are proposed, the yield of the produced chemicals is still too low and too diverse. The main obstacles encountered are related to the low solubility of CO2 into (aqueous) electrolytes, low selectivity of the catalyst and high Ohmic losses for electrolytes in which CO2 is well dissolved. The most common source of energy is solar radiation, which is used in combination with semiconductor materials to “pump” electrons to energy-levels corresponding to the desired redox-reactions. Even the most recent set-ups proposed by well established groups (Kamat, Grimes, Varghese) make use of aqueous electrolytes and a complex system of proton and electron generators.

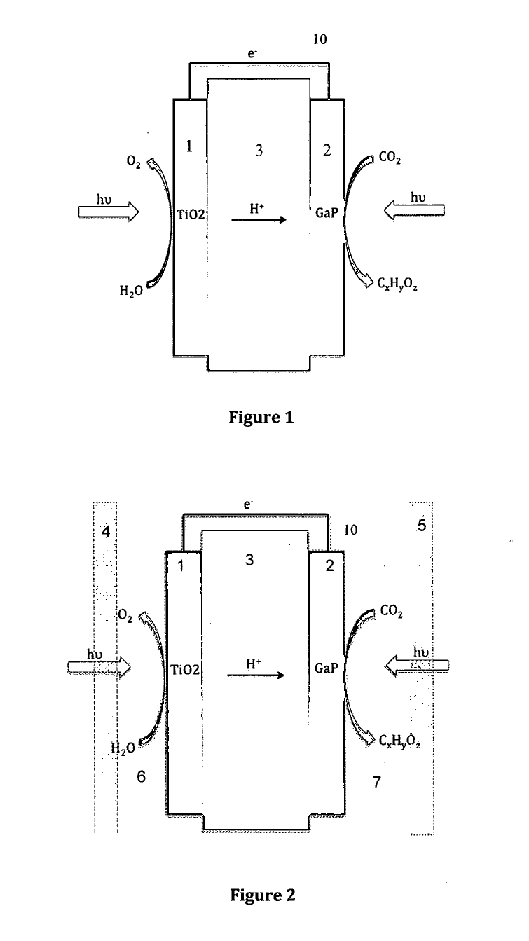

Shortly, here we propose a system where protons and electrons are generated by water-oxidation at a photocatalyst based on TiO₂, subsequently electrons are transported by means of an electric conductor and the protons migrate through a proton conducting membrane, as shown in FIG. 1. At the cathode the protons and electrons are in contact with a gas-stream containing or consisting out of CO₂. The first direct advantage of this set-up is the separation of both the oxidation and the reduction process. This configuration enables a separated improvement and tailoring of both catalysts. As a direct consequence one of the major issues, concerning the type of electrolyte used at the cathode, can be solved (pure CO2 can be used or an aqueous vapor as carrier gas). The design and synthesis of an ideal combination of catalysts and other molecules results hereby in the preferential formation of one single “fuel”, as will be explained in detail below.

### SUMMARY OF THE INVENTION

In accordance with the purpose of the invention, as embodied and broadly described herein, the invention is broadly drawn to the CO₂ conversion based on the photo-oxidation of water into oxygen gas O₂, protons H⁺, and electrons. The conversion of CO₂ occurs at the cathode and involves the generated protons, electrons and the ‘fuel” CO₂, see FIG. 1.

Schematically, three different macroscopic steps can be distinguished:
photo-catalytic oxidation of water by a photo-catalytic means that is interconnected with a second a means of by a photo-catalytic material
transport of electrons and transport of protons via the interconnecting means
photo-electrochemical conversion of CO₂ into useful chemicals at the second photocatlytic means

Schematically, different units and materials can be distinguished: (1) photo-catalytic material for oxidation of water interconnected by (2) a transport means of electrons and protons with (3) another photo-catalytic material for photo-electrochemical reduction of CO₂ and conversion of into useful chemicals

The present invention relates generally to a photo-electrochemical cell for conversion of light and air into useful chemicals or fuels and in particular for conversion of light and streams of moistened gas and carbon dioxide containing gas (, e.g. air) into organic compounds such as useful alcohol or hydrocarbon chemicals or fuels which comprises a first photocatalytic unit to photo-oxidize water of the moistened gas into oxygen and a second photocatalytic unit to photocatalytically reduce CO₂, whereby the first photocatalytic unit comprises a photocatalytic material that is interconnected by a positive charge (protons H+) transport means with photocatalytic material of a second photocatalytic unit whereby the first photocatalytic unit is and the second photo-catalytic unit receives radiation from a radiation source. Such photo-electrochemical cell interconnected photocatalyst materials form an anode and cathode electrode.

An example of a particular embodiment is a set-up based on a modified single-cell fuel cell, where both electrodes can be irradiated by the presence of a window made in quartz glass, the glass window contains a serpentine flow to promote good gasflow and thus enhance delivery and carry away products. The cell potential and electrochemical reactions, of both the overall reaction and the single cell reactions are monitored and determined by means of an electronic hardware required to control the photocatalytic electrodes in particular for maintaining the potential of the working electrode at a constant level for instance a potentiostat or a bipotentiostat

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Some embodiments of the invention are set forth here below.

According to the present invention, there is provided a photo-electrochemical cell or system for conversion of light and HO₂ from streams of moistened gas and carbon dioxide containing gas, e.g. air, into organic compounds such as useful alcohol or hydrocarbon chemicals or fuels, the cell or system hereby comprising a multiple photocatalytic system with a first photocatalyst electrode (1) to photo-oxidize water of the moistened gas into oxygen gas O₂ in contact by a positive charge (protons H⁺) transport means (3) with a second photocatalyst electrode (2) adapted to photocatalytically reduce CO2 whereby the cell further comprises at least one radiation means ((4) and/or (5) for radiation of the first (1) and the second photocatalyst (2). Such photo-electrochemical cell adapted to alcohol or hydrocarbon chemicals or fuels can be a single-cell fuel cell whereby when operational the both types of photocatalytic electrodes are irradiated. The irradiation of both electrodes can hereby occur by means of a quartz glass or any other UV or visible light transparent window on both sides. The irradiation can also occur by means of a UV/visible light transparent window at one side only, where the use of transparent electrodes enables irradiation of both electrodes is possible when only one side is directly irradiated.

The photo-electrochemical cell or system according to any one of the previous embodiments here above described can comprise the first electrode comprises an electrode material (carbon fibre structure, conducting glass nanofibre mesh) at least in part grafted by or functionalized by a nanoparticulate transition metal oxide photocatalyst, preferably of the titanium group consisting of Titanium (Ti), iron (Fe), tungsten (W). Zirconium (Zr), Hafnium (Hf) and Rutherfordium (Rf) and (b) incorporates N-atoms

In present invention the first photocatalytic electrode(s) and second photocatalytic electrode(s) are connected by an electron transport means (10) or circuit comprising a load (8) is the load on a circuit for electron transport from the first electrode(s) (1) to the second electrode(s) (2). In a specific suitable embodiment in above described photo-electrochemical cell or systems the first and the second photocatalytic electrode is connected by an electron transport means for instance a conducting metal-wire

According to an aspect of the present invention in the photo-electrochemical cell or system the photocatalyst of the first electrode is being doped with a trivalent metalloid element, for instance boron.

Furthermore in an aspect of the present invention such positive charge (protons H+) transport means, in the photo-electrochemical cell according to any one of the previous embodiments, comprises a material that allows movement of cations but the membranes do not conduct anions or electrons, nor are permeable for gasses. Furthermore such positive charge (protons H⁺) transport means comprises a Teflon membrane doped with nafion polymer. It is possible to enhance the proton transport through the positive charge (protons H⁺) transport by electric conducting polymers like polypyrrole or polyimidazoles and polyanilines, or it is facilitated by the presence of N-containing polycyclic hydrocarbons. The positive charge (protons H+) transport means can thus comprise one or more of these polymers.

The second photocatalyst electrode or electrode assembly (2) which adapted to photocatalytically reduce CO2 and to function as photocatalytic anode in the photo-electrochemical cell or system can comprise purely N-doped graphene sheets in combination with a p-type semiconductor (GaP, Cu₂O, SiC, NiO) or it can comprise N-doped (nitrogen doped) carbon nanotubes in combination with a p-type semiconductor (GaP, Cu₂O, SiC, NiO). Thus in addition to the N-doping of such second photocatalytic electrode it can comprises a p-type GaP, Cu₂O, NiO semiconductor for a selective reduction of CO₂.

Another aspect of present invention concerns the means for flowing water containing gas mixture over first electrode and a means to flow a CO2 rich gas over de second electrode comprised in such photo-electrochemical cell or system. There are alternatives alone or in combination to control such flow for instance the photo-electrochemical cell or system can comprise flow means controlled by an electro-osmotic pump, in a particular embodiment an electro-osmotic pump is based on PVA sponges. In yet another specific embodiment the electro-osmotic pump constructed to generate water flow by an electric field applied across a porous glass substrate. In this aspect a preferred design of the photo-electrochemical cell or system according to any of the previous embodiments of present invention comprises transparent material for instance a glass window adapted by a serpentine flow profile to provide optimal gas delivery to the electrodes and/or carry away reacted products.

Furthermore in alternative embodiments the previously described photo-electrochemical cells or photo-electrochemical systems comprises at least one electrochemical polycyclic aromatic hydrocarbon honeycomb cathode and/or the photocatalytic polycyclic aromatic hydrocarbon honeycomb anode comprises grapheme whereby:
the electrochemical and/or the photocatalytic polycyclic aromatic hydrocarbon honeycomb are in one-atom-thick planar sheet of sp2-bonded carbon atoms; or
wherein the electrochemical polycyclic aromatic hydrocarbon honeycomb cathode and/or the photocatalytic polycyclic aromatic hydrocarbon honeycomb anode comprises graphene in sheet; or
wherein the electrochemical honeycomb polycyclic aromatic hydrocarbon cathode and/or the photocatalytic polycyclic aromatic hydrocarbon honeycomb anode are stacked graphene sheets; or
wherein he electrochemical honeycomb polycyclic aromatic hydrocarbon cathode and/or the photocatalytic polycyclic aromatic hydrocarbon honeycomb in the form of carbon nanotubes. graphene sheets or fullerenes; or
wherein the polycyclic aromatic hydrocarbon honeycomb of the first photocatalytic electrode is photo-catalytically functionalized by molecular grafting of nanoparticulate as a photocatalyst; or
wherein the photocatalytic polycyclic aromatic hydrocarbon honeycomb of the first photocatalytic electrode comprises titanium dioxide, hematite or tungsten oxide WO3 nanoparticles. The titanium dioxide nanoparticles can hereby be spiked with carbon or nitrogen atoms or the titanium dioxide nanoparticles can be doped with metal oxide like tungsten trioxide, iron oxide, silver, silver oxides, copper or gold to function photocatalyst under either visible or UV light. In a particular embodiment such titanium dioxide in the form of nanoparticles (P25, Degussa), with or without coated silver and grafted on graphene sheets.

If the above described photo-electrochemical cells or photo-electrochemical systems are operation then the second photocatalyst electrode or electrodes function as cathode and CO₂ reduction occurs at such irradiated cathode by means of a photocatalytic reaction in particular embodiments such as CO₂ reduction occurs at the cathode by means of a photocatalytic reaction on a p-type semiconductor which comprises catalyst particles or films to enhance stability or catalytic activity and as demonstrated in examples such catalyst can be catalyzed with semiconductor particles composed of or comprising any of GaP, TiO2, SiC, CdS nanopowders or wafers, or electrodeposited thin films of the latter materials.

It is, inter alia, an object of the invention to provide such photo-electrochemical cell or system according to any one of the previous embodiments described here above with a wavelength modulation means to optimally irradiate the electrodes.

Furthermore in alternative embodiments the previously described photo-electrochemical cells or photo-electrochemical systems the second photocatalytic electrode comprises at least one electrochemical cathode graphene sheet fixed on a carbon cloth and in a specific embodiment the at least one electrochemical cathode graphene sheet is on electrode substrate (Toray paper, ITO nanofibre mesh) or the photocatalytic graphene sheet and/or chemoelectric graphene sheets incorporate N-atoms in sheets by N-doping or the photocatalytic graphene sheet and/or chemoelectric graphene sheets incorporate N-atoms in said sheets by NH₃ treatment.

It is, inter alia, an object of the invention to provide such photo-electrochemical cell or system with photocatalytic CO₂ reducing electrodes (second electrode or electrode assemblies as depicted in the figures) that absorb CO₂ from a CO₂ atmosphere or a gas mixture. To this end, a first aspect a photo-electrochemical cell according to any one of the embodiments concerns second photocatalyst electrode or second electrodes adapted to photocatalytically reduce CO₂ which are coated with a layer of CO2 absorbing material (9) adapted to absorption of CO₂ from an atmosphere, for instance from air. In a particular aspect such layer of CO₂ absorbing material (9) comprises metal-organic framework material (MOF's) Preferred MOF's are selected of the group consisting of MOF-177, MOF-5 and IRMOF-1. It is alternatively possible, however, to use layer of CO₂ absorbing material (9) comprises a CO₂ absorbing molecular sieve. In particular suitable is a the CO₂ absorbing molecular sieve, Zeolite 5A. Preferably the layer of CO₂ absorbing material (9) is 3-4 nm thick.

The electric transporting elements of the photo-electrochemical cells or photo-electrochemical systems of present invention concern the positive charge (protons H+) transport means and the electron transport means which interconnect anode and cathode (first and second photocatalyst electrodes) whereby various alternatives are possible such as the positive charge (protons H+) transport means is or comprises a conducting membrane for instance the positive charge transport means is or comprises a Nafion membrane and for instance the negative charge transport means is a conducting metal-wire and is provided with a load.

In a favorable embodiment, the photo-electrochemical cell or system according to invention of the here above described embodiments, potentiostat controller, such as to VersatSTAT adapted to monitore and determine cell potential and electrochemical reactions.

The invention also concerns the use of the photo-electrochemical cell or system according to any one of the previous embodiments to photo-oxidize water into oxygen gas O2, protons H+, and electrons to create a polarized electrical zone and to flow electric current flows through a electrochemical cathode contacting and reducing CO₂ into useful hydrocarbon compounds.

It is to be understood that both the foregoing general description and the following detailed description are exemplary and explanatory only and are not restrictive of the invention, as claimed.

### DETAILED DESCRIPTION

### Detailed Description of Embodiments of the Invention

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

### DEFINITIONS

Graphene is a one-atom-thick planar sheet of sp2-bonded carbon atoms that are densely packed in a honeycomb crystal lattice. It can be visualized as an atomic-scale chicken wire made of carbon atoms and their bonds.

Carbon nanotubes (CNTs) are allotropes of carbon with a cylindrical nanostructure.

A fullerene is any molecule composed entirely of carbon, in the form of a hollow sphere, ellipsoid, or tube. Spherical fullerenes are also called buckyballs, and cylindrical ones are called carbon nanotubes or buckytubes. Fullerenes are similar in structure to graphite, which is composed of stacked graphene sheets of linked hexagonal rings; but they can also contain pentagonal (or sometimes heptagonal) rings.

A first anode photocatalyst unit in the meaning of this application can comprise one photocatalyst anode or an assembly of anodes and a second photocatalyst unit can comprise one photcatalyst cathodes or an assembly of such cathodes.

In an aspect of present invention the dual photocatalytic single cell reactor of two types interconnection photocatalyst electrodes functionalized for different complementary photoelectrochemical functionalities in a single cell reactions of CO₂ conversion into organic molecules, whereby the photocatalytic reactor comprises an electronic controller to control the potential of the photocatalytic electrodes, preferably to maintain the potential of both types of photocatalytic electrode at a constant level under illumination. Such electronic controller that controles the electrochemical reaction can be a potentiostat such as a dipotentiostat.

Such photocatalytic single cell reactor of present invention for photocatalytic water splitting and photocatalytic CO₂ reduction is provided with a or a plurality of light transporters configured to transfer, transmit or reflect light to the surface of such photocatalytic reactor materials. Such light transporter or a light transporter of the plurality of light transporters for use by present invention is to efficiently transmit or reflect light from a medium or media to the photocatalytic materials or surfaces.

An irradiation source can be sunlight. In other instances, an irradiation source is an artificial light source. With this combination, natural light external to the cell is directed through the tube assembly into the interior of the cell to illuminate both types of photocatalyst electrodes.

The light transporter can comprise a light transfer window, light transporting or lens for light transfer onto the photocatalyst. The light transporter can comprise a prism, at least one mirror, and/or a fluorescent material. In some embodiments, the light transporter comprises a polymer, such as a plastic, and can be selected from the group consisting of polyethylenes, poiypropylenes, polyethylene terephthalates, polyacrylates, polyvinylchlorides, polycarbonates, and polystyrenes. In some instances, a light transporter comprises quartz, glass or resin-supported fiberglass. The light transporter can comprise a filter. A top surface of a light transporter can be partly flat, convex, or concave. A typical light transporter is a for instance a tubular skylight, a skylight tube or longitudinal shaft which has for instance been disclosed in U.S. Pat. No. 5,896,713, U.S. Pat. No. 7,621,081, U.S. Pat. No. 5,896,712 and U.S. Pat. No. 6,035,593 such devices or other light tubes or cylindrical shafts for instance mirrored ones according to present invention can be used to transport light to the photocatalyst reactors for water splitting or for CO₂ reduction. Such skylight tube or longitudinal shaft can be solid, rigid, or hollow. A cross sectional shape of the longitudinal shaft can be circular, oval, square, rectangular, triangular, hexagonal, polygonal or any variation or mixture thereof.

A light transporter or a light transporter of the plurality of light transporters can comprise longitudinal shaft which is at least partially transparent to a wavelength of light capable of driving the photocatalytic process and whereby the light transporter can be foreseen by a wave length convertor, for instance a downshifting material, to improve the quantum efficiency. Such wave length converter can be as for instance described in US20100186801, by N. N. Barashkov et al. Zhurnal Prikladnoi Spektroskopii, Vol. 55, No. 6, pp. 906-918, December, 1991, U.S. Pat. No. 4,251,284 or the on internet posted study by Berkeley research students Becca Jones, Nanocrystalline Luminescent Solar Converters dated 2004. Such luminescence downshifting material cone comprise one or more of the following samarium ion (Sm³⁺), chromium ion (Cr³⁺), zinc selenide, europium ion (Eu²⁺), terbium ion (Tb³⁺), a semiconducting quantum dot material, and silver nanoparticles

### EXAMPLES

### Example 1

The photo-electrochemical cell, system or method for conversion of light and air into chemicals and, more particularly to a system which comprises the fowling steps and elements:

1.a. The Electrodes at Both Anode and Cathode

The electrode consists out of carbon cloth or Toray paper in some cases coated with graphene sheets. The graphene sheets deposited on carbon cloth/Toray paper by means of RF-CVD or MW-CVD can be made e.g. according to a method of Wang, J. J. et al. (2004) Carbon, 42(14): 2867-2872 or Zhao, X et al. Journal of Power Sources, Volume 194, Issue 2, December 2009, Pages 1208-1212.

The cell comprises the use of glass windows with a transparent serpentine flow profile, similar to those encountered in H2/O2 fuel cells, custom made by for example Safir Puurs.

1.b. Photo-Oxidation

The photo-catalytic oxidation reaction will occur initially on a catalytic substrate based on titanium dioxide in the form of nanoparticles (such as TiO₂, P25 grade, Degussa). These nanopartciles are grafted on graphene/graphite preferably graphene sheets to form a P25-graphene photocatalyst. A possible procedure is described in Hao Zhang et al. CS Nano, 2010, 4 (1), pp 380-386. Additionally, the titanium dioxide catalyst can be coated with silver, or doped with nitrogen or carbon, modified with iron oxide to enhance the affinity to the visible light spectrum. The creation of periodically ordered structures enhances and induces photonic properties [Oomman K et al. Nano Lett., 2009, 9 (2), pp 731-737]. The present in an embodiment also involves wavelength modulation and/or favored propagation of specific wavelengths for instance by a wavelength convertor as described in WO2009006708. The catalytic properties are modified by adding metal particles, for instance particles of an Fe element and at least one element selected from the group consisting of V, Nb, Ta, Cr, Mo, W, Mn, Tc, and Re or a metal particle composed of a combination of Fe and Mo, Fe and Cr, Fe and Ce, Fe and Mn or the like. Additionally, to slow down direct and indirect recombination of electron-hole pairs the graphene sheets are doped, preferably with boron, to enhance the “electron capture ability”.

In an embodiment of present invention the high over-potentials needed for the process are “naturally” generated by stacks of photovoltaics and commonly used silicon photovoltaics in addition to the built-in potential of the semi-conductor metal junction present at both electrodes. An example of useful photovoltaics is provided by (Michael Grätzel Nature 414, 338-344 (15 Nov. 2001).

The water flow in the photo-electrochemical cell, system of present invention is preferably controlled by an electro-osmotic pump, for instance an electro-osmotic pump based on PVA sponges and hollow glass substrates. This allows good control of the flow-rate of water while avoiding flooding effects.

1.c. Charge Transport

The transport of the electrons and protons occurs in a preferred embodiment by means of a simple conducting metal-wire or a Nafion based membrane, respectively. The proton transport on the electrode surface in addition is enhanced by means of conducting polymers like polypyrrole or polyimidazoles.

The proton transport can occur by means of a commercial available Nafion membrane (Dupont, for example types 112, 115, 117). Or an assembly of a thin PTFE foil (Gore) with Nafion polymer (based on an ethanolic solution, Sigma Aldrich) is fabricated by various methods (for example spincoating, dropcasting, Langmuir-Blodgett, vacuum deposition) for enhancing thermal stability.

1.d. Reduction of CO2

The electrochemical conversion (reduction) of CO2 into any other chemical is considered as the most difficult step in the conversion process. Depending on the exact reaction mechanism, high overpotentials can be expected (˜2V). The electrons generated in the photo-oxidation step are excited into higher energy levels by means of a second photosystem in order to enable the CO₂ reduction. This second photosystem comprises a p-type semiconductor (GaP, Cu₂O, NiO).

A p-type GaP electrode is fabricated by deposition of GaP nanoparticles on the substrate (Toray paper, ITO or FTO nanofibres mesh fabricated by electrospinning) or direct growth of GaP by means of electrodeposition.

A p-type Cu₂O electrode is fabricated by deposition of Cu₂O nanoparticles on the substrate (Toray paper, ITO or FTO nanofibres mesh fabricated by electrospinning) or direct growth of Cu₂O by means of electrodeposition. Electrodeposition bath in this case comprises CuSO₄ and lactate solution at cathodic potentials of −0.35 V versus Ag/AgCl reference electrode.

The stability of these p-type electrodes is enhanced by applying a coating of Ni, or Cu, or Mo, or Cr, or Mn. The coating is performed by means of photodeposition, spincoating, dipcoating, spraycoating, or dropcasting.

Coating the cathode electrode with a thin layer of absorbing material enhances the absorption of carbon dioxide from atmospheric air. For example MOF's are well-known for their high capture efficiency and high absorption selectivity of carbon dioxide (MOF-177, MOF-5, IRMOF-1). Also zeolites (5A) are known for their good absorbing capacities of carbon dioxide. Thin films of the latter materials can be grown/deposited directly on the electrodes by means of spincoating, Langmuir-Blodgett techniques or dropcasting.

An example of the involved energybands, proton and electron transport as discussed in previous section, is illustrated in FIG. 2.

Other embodiments of the invention will be apparent to those skilled in the art from consideration of the specification and practice of the invention disclosed herein. It is intended that the specification and examples be considered as exemplary only.

Each and every claim is incorporated into the specification as an embodiment of the present invention. Thus, the claims are part of the description and are a further description and are in addition to the preferred embodiments of the present invention.

Each of the claims set out a particular embodiment of the invention.

### DRAWING DESCRIPTION

### Brief Description of the Drawings

The present invention will become more fully understood from the detailed description given herein below and the accompanying drawings which are given by way of illustration only, and thus are not limitative of the present invention, and wherein:

FIG. 1 is a schematic overview of an example of the electrochemical cell for CO2 conversion into fuels. (1) is the first photocatalytic electrode or group of photocatalytic electrodes and activate it to split water, (2) is a second electrode or group of second electrodes for CO2 reduction, (3) is positive charge (protons H+) transport means that connects the first photocatalyst electrode (1) or first electrodes assembly (1) to photo-oxidize water of the moistened gas into oxygen gas O₂ with the second photocatalyst electrode (2) or second photocatalyst electrodes assembly (2) to photocatalytically reduce CO2.

FIG. 2 is a schematic overview of an example of the electrochemical cell for CO2 conversion into fuels (1) is an example of the first photocatalyst electrode (1) or first electrodes assembly (1) to photo-oxidize water of the moistened gas into oxygen gas O₂, (2) is an example of the second photocatalyst electrode (2) or second photocatalyst electrodes assembly (2) to photocatalytically reduce CO2, (3) is an example of a positive charge (protons H+) transport means that connects the first photocatalyst electrode (1) or first electrodes assembly (1) to photo-oxidize water of the moistened gas into oxygen gas O₂ with the second photocatalyst electrode (2) or second photocatalyst electrodes assembly (2) to photocatalytically reduce CO2 (4) and (5) are radiation means for instance windows or lamps, to respectively radiate (1) and (2). Alternatively (4) can be a window transparent for UV/visible light and (5) can be a mirror. In this case the electrodes are made of UV/visible light transparent materials (for example ITO or FTO nanofibres meshes). Using (5) as a transparent window and (4) as a mirror is also comprised in the description. For the embodiments of these invention the radiation means (4) and (5) can be the same.

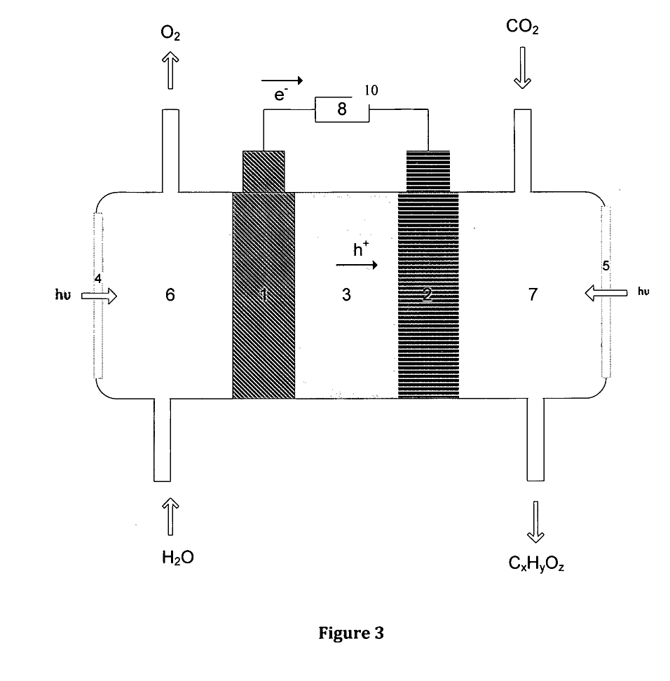

FIG. 3 provides a schematic overview of an example of the electrochemical cell, more particular the single cell, for CO2 conversion into fuels whereby (1) is an example of a first electrode or group of first electrodes for water splitting, whereby (2) is an example of a second electrode or group of second electrodes for, whereby (4) is example of radiation means in this case windows that allow light that is external to the cell to enter in the chamber, eventually flow through chamber (6) and to radiate the first photocatalytic electrode (1) or group of photocatalytic electrodes (1) and activate it to split water and (5) is example of radiation means in this case windows that allow light that is external to the cell to enter in the chamber (7), eventually flow through chamber (7) and to radiate the second photocatalytic electrode (2) that hereby is activated to reduce CO2 the chamber (7), and whereby (8) is the load on a circuit for electron transport from the first electrode(s) (1) to the second electrode(s) (2) and whereby (3) is positive charge (protons H+) transport means that connects the first photocatalyst electrode (1) or first electrodes assembly (1) to photo-oxidize water of the moistened gas into oxygen gas O₂ with the second photocatalyst electrode (2) or second photocatalyst electrodes assembly (2) adapted to photocatalytically reduce CO2. (4) and (5) can be a mirror or transparent window for UV/visible light if transparent electrodes are used.

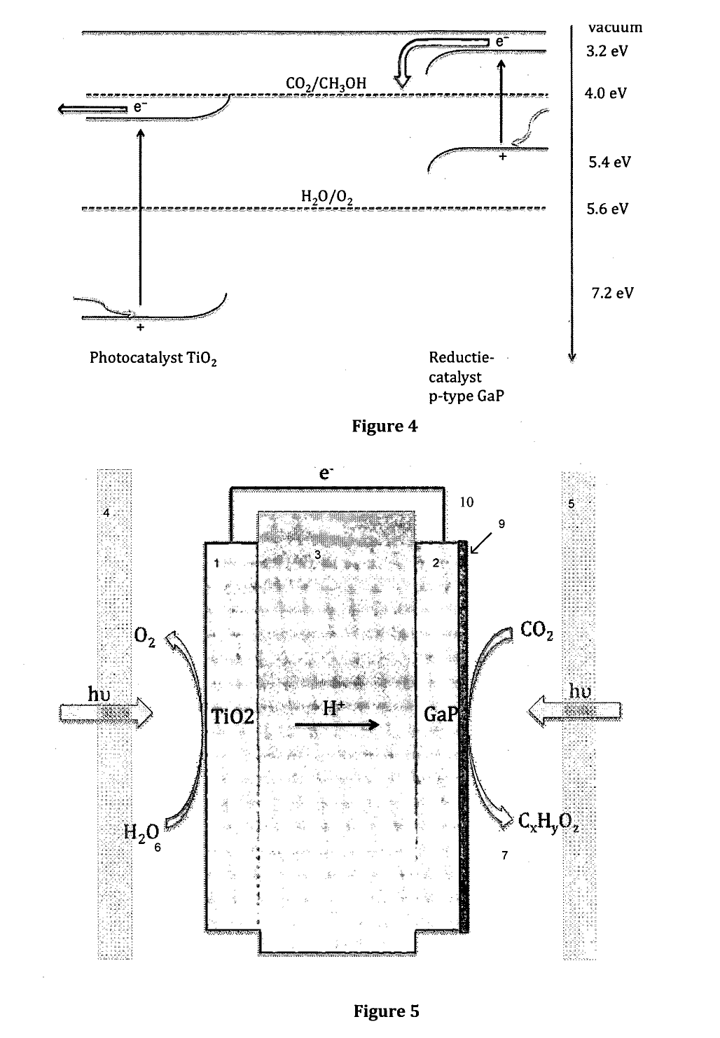

FIG. 4 is an example of the possible energy-bands, protons, and electrons of the involved interactions.

FIG. 5 provides a schematic overview of an example of the electrochemical cell as in FIG. 3 and displays the CO₂ absorbing layer (9) to absorb CO₂ from an atmosphere onto the second photocatalyst electrode (2) or second photocatalyst electrodes assembly (2) adapted to photocatalytically reduce CO₂.

In interpreting these claims, it should be understood that:

a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or function;
g) any of the disclosed devices or portions thereof may be combined together or separated into further portions unless specifically stated otherwise;
h) no specific sequence of acts is intended to be required unless specifically indicated; and
i) the term “plurality of” an element includes two or more of the claimed element, and does not imply any particular range of number of elements; that is, a plurality of elements can be as few as two elements.

1. A photo-electrochemical cell for conversion of light, of water (H₂O) in streams of moistened gas and of carbon dioxide (CO₂) in streams of CO₂ containing gas (e.g. air, nitrogen carrier gas) into organic compounds such as useful alcohol or hydrocarbon chemicals or fuels wherein the cell comprises a or a plurality of photocatalytic systems each with a first photocatalyst electrode or an assembly of such first photocatalyst electrodes adapted to photo-oxidize water of the moistened gas into oxygen gas O₂ (1) such first electrode or plurality of first electrodes in contact by a positive: charge (protons H⁺) transport means (3) with a second photocatalyst electrode or an assembly of second photocatalyst electrodes adapted to photocatalytically reduce CO₂ (2) which cell further comprises at least one radiation means (4) and/or (5)) adapted to irradiate the first (1) and the second photocatalyst electrode (2).

2. The photo-electrochemical cell of claim 1, which comprises a first photocatalytic unit adapted to receive the moistened gas and to photo-oxidize water of the moistened gas into oxygen and a second photocatalytic unit adapted to receive CO₂ or a gas comprising CO), and to photocatalytically reduce CO₂, whereby the first photocatalytic unit comprises a photocatalytic material that is interconnected by a positive charge (protons H⁺) transport means (3) with photocatalytic material of a second photocatalytic unit and further comprising connected by an electron transport means (10) whereby the interconnected first photocatalyst and second photocatalyst form an anode and cathode electrode when receiving radiation from a radiation source.

3. The photo-electrochemical cell according to claim 1, wherein it is a single-cell fuel cell whereby when operational the both types of photocatalytic electrodes are irradiated.

4. The photo-electrochemical cell according to claim 1, whereby second photocatalyst electrode adapted to photocatalytically reduce CO, or plurality second electrodes adapted to photocatalytically reduce CO, are at least in part coated with a layer of CO₂ absorbing material (9) such layer being adapted to absorption of CO₂ from an atmosphere.

5. The photo-electrochemical according to claim 4, whereby the layer of CO₂ absorbing material (9) comprises metal-organic framework material. (MOF's).

6. The photo-electrochemical according to claim 5, whereby the MOP is selected from the group consisting of MOF-177. MOF-5 and IRMOF-1.

7. The photo-electrochemical according to claim 4, whereby the layer of CO₂ absorbing material (9) comprises a CO₂ absorbing molecular sieve.

8. The photo-electrochemical according to claim 7, whereby the CO₂ absorbing molecular sieve is a Zeolite 5A.

9. The photo-electrochemical according to claim 4, whereby the layer of CO₂ absorbing material (9) is 3-4 nm thick.

10. The photo-electrochemical cell according to claim 1 whereby the at least one radiation means ((4) and/or (5)) is a UV and/or visible light transparent window adapted to irradiation both the first and the second electrodes or the photocatalyst materials.

11. The photo-electrochemical cell according to claim 1, whereby the at least one radiation means ((4) and/or (5) is a quartz glass window adapted to irradiation both the first photocatalytic unit and said the second photocatalytic unit.

12. The photo-electrochemical cell according to claim 1, whereby the first photocatalyst electrode or electrodes (1) are transparent and whereby the at least one radiation means ((4) and/or (5)) is an UV and/or visible light transparent window adapted to directly irradiation the first transparent electrode or electrodes (1) and indirectly through the first transparent electrodes (1) the second photocatalyst electrodes (2).

13. The photo-electrochemical cell according to claim 1, whereby the second photocatalyst electrode or electrodes (2) are transparent and whereby the at least one radiation means ((4) and/or (5)) is an UV and/or visible light transparent window adapted to directly irradiation the second transparent electrode or electrodes (2) and indirectly through the second transparent electrodes (1) the first photocatalyst electrodes (1).

14. The photo-electrochemical cell according to claim 1, whereby the charge transport means comprises a material to allow movement of cations but whereby the material does not conduct anions or electrons nor is permeable for gasses.

15. The photo-electrochemical cell according to claim 1, whereby both the anode and the cathode or both the first electrode and second electrode comprise a graphene coated carbon fabric.

16. The photo-electrochemical col according to claim 1, whereby the charge transport means comprises a Nation membrane.

17. The photo-electrochemical cell according to claim 1, whereby the charge transport means comprises a Teflon membrane doped with Nation polymer.

18. The photo-electrochemical cell according to claim 1, whereby the proton transport is enhanced by means of conducting polymers like polypyrrole or polyimidazoles.

19. The photo-electrochemical cell according to claim 1, whereby the first electrode or electrodes or the photo-catalytic-oxidation anode adapted to photo-oxidize water comprises titanium dioxide catalyst nanoparticles grafted on the electrode.

20. The photo-electrochemical cell of claim 19, whereby the titanium dioxide catalyst is coated with sliver to enhance the affinity to the visible light spectrum.

21. The photo-electrochemical cell according to claim 19, whereby the catalytic properties are modified by adding metal particles.

22. The photo-electrochemical cell according to claim 19, whereby the graphene sheets are doped, preferably with boron, to enhance the “electron capture ability”.

23. The photo-electrochemical cell according to claim 1, whereby the second electrode or electrodes or photocatalytic cathode adapted for reduction of CO—) comprises purely N-doped graphene sheets.

24. The photo-electrochemical cell according to of the claim 1, whereby the second electrode or electrodes or photocatalytic cathode adapted for reduction of CO₂ comprises N-doped (nitrogen, doped) carbon nanotubes in combination with a p-type semiconductor from the group consisting of GaP, Cu₂O, SiC and NiO.

25. The photo-electrochemical cell according to claim 1, whereby the second electrode or electrodes or photocatalytic cathode adapted for reduction of CO₂ comprises N-doped (nitrogen doped) carbon nanotubes and/or N-doped graphene sheets in combination with a p-type semiconductor from the group consisting of GaP, Cu₂O, SIC and NiO.

26. The photo-electrochemical cell according to claim 22, whereby the graphene sheet is NH₃ treated for the incorporation of N-atoms in the sheets.

27. The photo-electrochemical cell according to claim 22, whereby in addition to the N-doping, a p-type GaP semiconductor is used for a selective reduction of CO₂.

28. The photo-electrochemical cell according to claim 1, wherein it is a single-cell fuel cell whereby the radiation means to irradiate both types of photocatalytic electrodes is a window made in quartz glass.

29. The photo-electrochemical cell according to claim 1, wherein cell further comprises an electronic controller to control the potential of the photocatalytic electrodes.

30. The photo-electrochemical cell according to claim 1, wherein cell further comprises an electronic controller for maintaining the potential of both types of photocatalytic electrode at a constant level.

31. The photo-electrochemical cell according to claim 1, wherein cell further comprises an electronic controller adapted to control the electrochemical reactions.

32. The photo-electrochemical cell according to claim 29, wherein the electronic controller is a potentiostat.

33. The photo-electrochemical cell according to claim 29, wherein the electronic controller is a bipotentiostat.

34. The photo-electrochemical cell according to claim 1, which comprises at least one unit comprising at least two flow-through compartments: this unit is at least in part formed by an encapsulation means or a cover means and a sequence or stack of layers of positive charge (protons H⁺) transport means between the first photocatalyst material to photo-oxidize water, and the second photocatalyst material to photocatalytically reduce CO₂ further wherein the compartments of the unit are at least in part formed by a outer wall of encapsulation means or a cover means and an inner photocatalyst material, whereby the first compartment that is at toast in part formed by an encapsulation means and a first photocatalyst material to photooxidize water and the second compartment is at least in part formed by an encapsulation means and a second photocatalyst material to photocatalytiealiy reduce CO₂.

35. The photo-electrochemical cell of claim 34, whereby encapsulation means comprises a radiation means.

36. The photo-electrochemical cell of claim 34, whereby encapsulation means is at least in part a radiation means.

37. The photo-electrochemical cell according to claim 1, whereby the radiation means comprises or is a window at least partially transparent to a wavelength of light.

38. The photo-electrochemical cell according to claim 1, whereby the radiation means comprises or is a window transparent to a wavelength of light capable of driving the photocatalytic process.

39. The photo-electrochemical cell according to claim 1, whereby the radiation means comprises or is a light transporter for transporting light from a light source towards the photocatalyst.

40. The photo-electrochemical cell according to claim 1, whereby the photo-electrochemical cell comprises a or a plurality of light transporters configured to transfer, transmit or reflect light, to the surface of such photocatalytic reactor materials.

41. The photoelectrochemical cell according to claim 1, comprising a light transporter to direct natural light external to the photo electrochemical cell into the interior of the photo-electrochemical cell to illuminate the photocatalytic materials.

42. The photo-electrochemical cell according to the claim 1, comprising a light transporter to direct through a tube assembly natural light external to the photo-electrochemical cell into the interior of the photo-electrochemical cell to illuminate the photocatalytic materials.

43. The photo-electrochemical cell according to claim 1, comprising a light transporter to more efficiently transmit or reflect light from a medium to the photocatalytic materials or surfaces.

44. The photo-electrochemical cell according to claim 1, comprising a light transporter to transport light to the photocatalyst reactors for water splitting or and the photocatalyst reactors for CO₂ reduction.

45. The photo-electrochemical cell according to claim 1, whereby the radiation means is foreseen by a wavelength converter to improve the quantum efficiency at the photocatalysator or the surfaces to the photocatalytic material.

46. The photo-electrochemical cell according to claim 1, comprising an irradiation source.

47. The photo-electrochemical cell according to claim 1, comprising an irradiation source which is sunlight.

48. The photo-electrochemical cell according to claim 1, comprising an artificial light source.

49. The photo-electrochemical cell or system according to claim 1, which comprises transparent material.

50. The use of a photo-electrochemical cell according to claim 1, for conversion of light and air into useful chemicals or fuels and in particular for conversion of light and streams of moistened gas and carbon dioxide containing gas into organic compounds such as useful alcohol or hydrocarbon chemicals or fuels.

51. The photo-electrochemical cell according to claim 1, whereby the second electrode or electrodes or photocatalytic cathode adapted for reduction of CO₂ comprises second electrode or electrodes or photocatalytic cathode adapted for reduction of CO₂ comprises a p-type semiconductor which comprises catalyst particles or films.

52. The photo-electrochemical cell according to claim 1, whereby positive charge (protons H⁺) transport means is a membrane.

53. The photo-electrochemical cell according to claim 1, whereby the positive charge (protons H+) transport means interconnects anode and cathode (first and second photocatalyst electrodes)

54. The photo-electrochemical cell according to claim 1, further comprising a means to flow a CO₂ rich gas over de second electrode comprised in such photo-electrochemical cell or system.

55. A photo-electrochemical cell for conversion of light, of water (H₂O) in streams of moistened gas and of carbon dioxide (CO₂) in streams of CO₂ containing gas (e.g. air, nitrogen carrier gas) into organic compounds such as useful alcohol or hydrocarbon chemicals or fuels wherein the cell is a single-cell foci cell which comprises a positive charge (protons H⁺) transport means which comprises a material that allows movement of cations but does not conduct anions or electrons, nor is permeable for gasses and further comprises a or a plurality of photocatalytic systems each with a first photocatalyst electrode or an assembly of such first photocatalyst electrodes adapted to photo-oxidize water of the moistened gas into oxygen gas O2 [1] such first electrode or plurality of first electrodes in contact by the positive charge (protons H+) transport means (3) with a second photocatalyst electrode or an assembly of second photocatalyst electrodes adapted to photocatalytically reduce CO₂ (2) which cell further comprises at least one radiation means ((4) and/or (5)) adapted to irradiate the first (1) and the second photocatalyst electrode (2) and whereby second photocatalyst electrode adapted to photocatalytically reduce CO₂ or plurality second electrodes adapted to photocatalytically reduce CO, are at least in part is coated with a layer of CO₂ absorbing material (9) such layer being, adapted to absorption of CO₂ from an atmosphere.

56. The photo-electrochemical cell of claim 55, which comprises to first photocatalytic unit adapted to receive the moistened gas and to photo-oxidize water of the moistened gas into oxygen and a second photocatalytic unit adapted to receive CO, or a gas comprising CO, and to photocatalytically reduce CO₂, whereby the first photocatalytic unit comprises a photocatalytic material that is interconnected by a positive charge (protons H⁺) transport means (3) with photocatalytic material of a second photocatalytic unit and further comprising connected by an electron transport means (10) so that at the cathode the protons and electrons are in contact with a gas-stream containing, or consisting out of CO₂ and whereby the interconnected first photocatalyst and second photocatalyst form an anode and cathode electrode when receiving radiation from a radiation source.

57. The photo-electrochemical cell according to claim 55, which comprises at least one unit comprising at least two flow through compartments; this unit is at least in pan formed by an encapsulation means or a cover means and a sequence or stack of layers of positive charge (protons H+) transport means between the first photocatalyst material to photo-oxidize water, and the second photocatalyst material to photocatalytically reduce CO₂ further wherein the compartments of the unit are at least in part formed by an outer wall of encapsulation means or a cover means and an inner photocatalyst material, whereby the first compartment that is at least in part formed by an encapsulation means and a first photocatalyst material to photo oxidize water and the second compartment is at least in part formed by an encapsulation means and a second photocatalyst material to photocatalytically reduce CO₂.
